(19) United States
(12) Patent Application Publication
(10) Pub. No.: US 2021/0367686 A1
(43) Pub. Date: Nov. 25, 2021

(54) INDICATIONS OF A POWER AMPLIFIER NONLINEARITY STATE

(71) Applicant: QUALCOMM Incorporated, San Diego, CA (US)

(72) Inventors: Igor GUTMAN, Ramat Gan (IL); Sharon LEVY, Binyamina (IL); Guy WOLF, Rosh Haayin (IL)

(21) Appl. No.: 17/325,663

(22) Filed: May 20, 2021

Related U.S. Application Data
(60) Provisional application No. 63/029,014, filed on May 22, 2020.

(51) Int. Cl. H04B 17/13; H04W 72/04; H04W 52/08; H04W 52/24

(52) U.S. Cl. CPC H04B 17/13; H04W 52/248; H04W 52/08; H04W 72/0473

(57) ABSTRACT

Various aspects of the present disclosure generally relate to wireless communication. In some aspects, a first wireless communication device may receive an indication of a power amplifier nonlinearity state to use for transmitting a communication to a second wireless communication device, and transmit the communication based at least in part on the indication of the power amplifier nonlinearity state. Numerous other aspects are provided.

### CROSS-REFERENCE TO RELATED APPLICATION

This Patent Application claims priority to Provisional Patent Application No. 63/029,014, filed on May 22, 2020, entitled “INDICATIONS OF A POWER AMPLIFIER NONLINEARITY STATE,” and assigned to the assignee hereof. The disclosure of the prior Application is considered part of and is incorporated by reference in this Patent Application.

### FIELD OF THE DISCLOSURE

Aspects of the present disclosure generally relate to wireless communication and to techniques and apparatuses for indications of a power amplifier nonlinearity state.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. “Downlink” (or “forward link”) refers to the communication link from the BS to the UE, and “uplink” (or “reverse link”) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication, performed by a first wireless communication device, may include receiving an indication of a power amplifier nonlinearity state to use for transmitting a communication to a second wireless communication device; and transmitting the communication based at least in part on the indication of the power amplifier nonlinearity state.

In some aspects, a method of wireless communication, performed by a first wireless communication device, may include receiving, from a second wireless communication device, an indication of a power amplifier nonlinearity state used by the second wireless communication device to transmit a communication; and estimating a nonlinearity of the communication based at least in part on the indication of the power amplifier nonlinearity state.

In some aspects, a method of wireless communication, performed by a first wireless communication device comprising, may include transmitting, to a second wireless communication device, an indication of a power amplifier nonlinearity state used to transmit a communication; and transmitting, to the second wireless communication device, the communication based at least in part on the power amplifier nonlinearity state.

In some aspects, a method of wireless communication, performed by a first wireless communication device, may include transmitting, to a second wireless communication device, an indication of a power amplifier nonlinearity state to use for transmitting a communication to the first wireless communication device; and estimating a nonlinearity of the communication based at least in part on the indication of the power amplifier nonlinearity state.

In some aspects, a first wireless communication device for wireless communication may include a memory and one or more processors coupled to the memory. The one or more processors may be configured to receive an indication of a power amplifier nonlinearity state to use for transmitting a communication to a second wireless communication device; and transmit the communication based at least in part on the indication of the power amplifier nonlinearity state.

In some aspects, a first wireless communication device for wireless communication may include a memory and one or more processors coupled to the memory. The one or more processors may be configured to receive, from a second wireless communication device, an indication of a power amplifier nonlinearity state used by the second wireless communication device to transmit a communication; and estimate a nonlinearity of the communication based at least in part on the indication of the power amplifier nonlinearity state.

In some aspects, a first wireless communication device for wireless communication may include a memory and one or more processors coupled to the memory. The one or more processors may be configured to transmit, to a second wireless communication device, an indication of a power amplifier nonlinearity state used to transmit a communication; and transmit, to the second wireless communication device, the communication based at least in part on the power amplifier nonlinearity state.

In some aspects, a first wireless communication device for wireless communication may include a memory and one or more processors coupled to the memory. The one or more processors may be configured to transmit, to a second wireless communication device, an indication of a power amplifier nonlinearity state to use for transmitting a communication to the first wireless communication device; and estimate a nonlinearity of the communication based at least in part on the indication of the power amplifier nonlinearity state.

In some aspects, a non-transitory computer-readable medium may store one or more instructions for wireless communication. The one or more instructions, when executed by one or more processors of a first wireless communication device, may cause the one or more processors to receive an indication of a power amplifier nonlinearity state to use for transmitting a communication to a second wireless communication device; and transmit the communication based at least in part on the indication of the power amplifier nonlinearity state.

In some aspects, a non-transitory computer-readable medium may store one or more instructions for wireless communication. The one or more instructions, when executed by one or more processors of a first wireless communication device, may cause the one or more processors to receive, from a second wireless communication device, an indication of a power amplifier nonlinearity state used by the second wireless communication device to transmit a communication; and estimate a nonlinearity of the communication based at least in part on the indication of the power amplifier nonlinearity state.

In some aspects, a non-transitory computer-readable medium may store one or more instructions for wireless communication. The one or more instructions, when executed by one or more processors of a first wireless communication device, may cause the one or more processors to transmit, to a second wireless communication device, an indication of a power amplifier nonlinearity state used to transmit a communication; and transmit, to the second wireless communication device, the communication based at least in part on the power amplifier nonlinearity state.

In some aspects, a non-transitory computer-readable medium may store one or more instructions for wireless communication. The one or more instructions, when executed by one or more processors of a first wireless communication device, may cause the one or more processors to transmit, to a second wireless communication device, an indication of a power amplifier nonlinearity state to use for transmitting a communication to the first wireless communication device; and estimate a nonlinearity of the communication based at least in part on the indication of the power amplifier nonlinearity state.

In some aspects, an apparatus for wireless communication may include means for receiving an indication of a power amplifier nonlinearity state to use for transmitting a communication to a wireless communication device; and means for transmitting the communication based at least in part on the indication of the power amplifier nonlinearity state.

In some aspects, an apparatus for wireless communication may include means for receiving, from a wireless communication device, an indication of a power amplifier nonlinearity state used by the wireless communication device to transmit a communication; and means for estimating a nonlinearity of the communication based at least in part on the indication of the power amplifier nonlinearity state.

In some aspects, an apparatus for wireless communication may include means for transmitting, to a wireless communication device, an indication of a power amplifier nonlinearity state used to transmit a communication; and means for transmitting, to the wireless communication device, the communication based at least in part on the power amplifier nonlinearity state.

In some aspects, an apparatus for wireless communication may include means for transmitting, to a wireless communication device, an indication of a power amplifier nonlinearity state to use for transmitting a communication to the apparatus; and means for estimating a nonlinearity of the communication based at least in part on the indication of the power amplifier nonlinearity state.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, or artificial intelligence-enabled devices). Aspects may be implemented in chip-level components, modular components, non-modular components, non-chip-level components, device-level components, or system-level components. Devices incorporating described aspects and features may include additional components and features for implementation and practice of claimed and described aspects. For example, transmission and reception of wireless signals may include a number of components for analog and digital purposes (e.g., hardware components including antennas, radio frequency (RF) chains, power amplifiers, modulators, buffers, processor(s), interleavers, adders, or summers). It is intended that aspects described herein may be practiced in a wide variety of devices, components, systems, distributed arrangements, or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example associated with indications of a power amplifier nonlinearity state, in accordance with the present disclosure.

FIG. 4 is a diagram illustrating an example associated with indications of a power amplifier nonlinearity state, in accordance with the present disclosure.

FIGS. 5-8 are diagrams illustrating example processes associated with indications of a power amplifier nonlinearity state, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

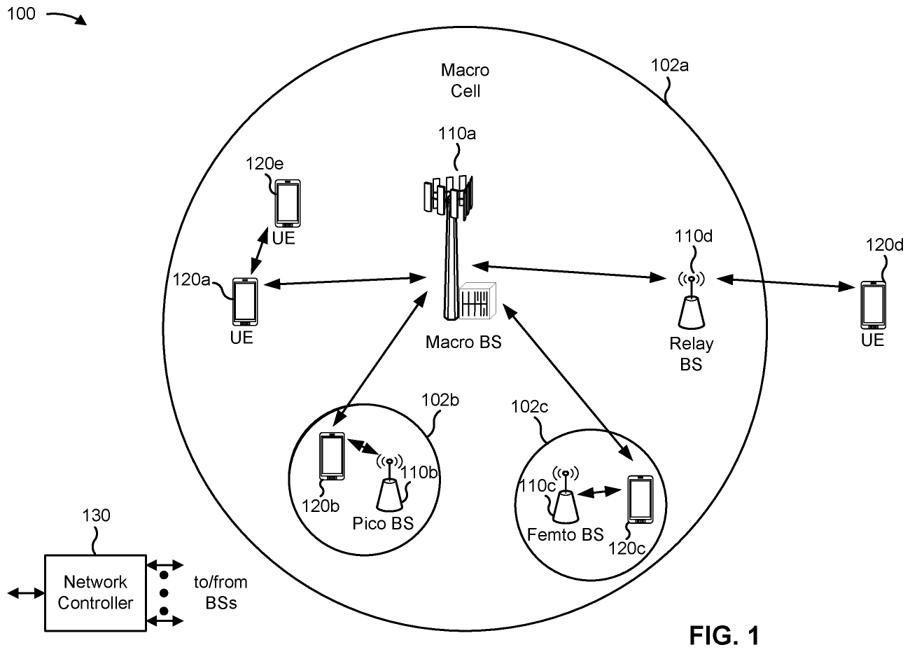

FIG. 1 is a diagram illustrating an example of a wireless network 100, in accordance with the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). ABS for a macro cell may be referred to as a macro BS. ABS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, directly or indirectly, via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

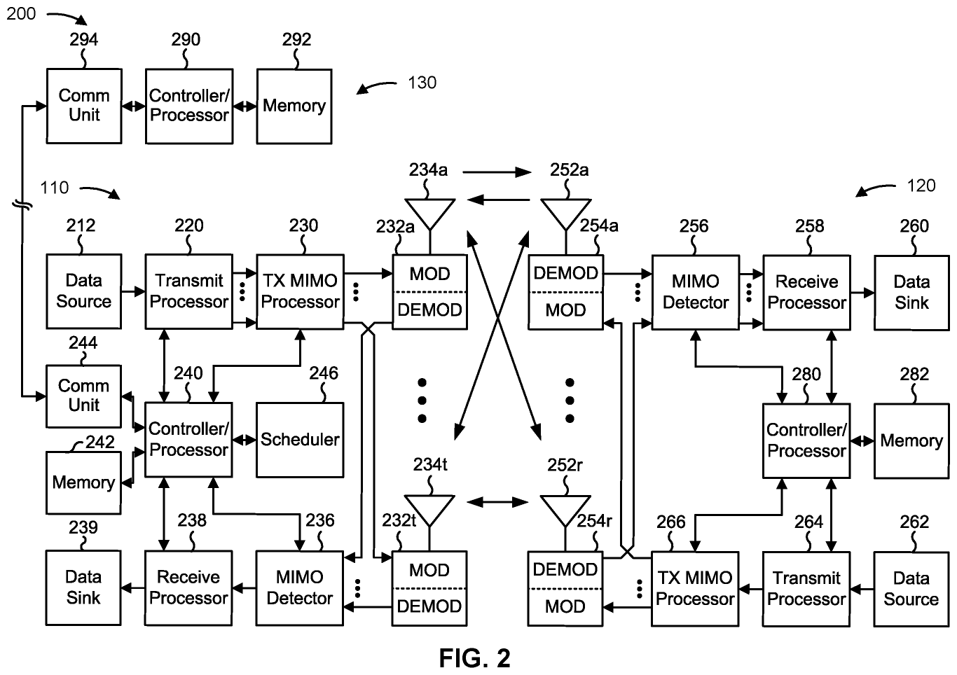

FIG. 2 is a diagram illustrating an example 200 of a base station 110 in communication with a UE 120 in a wireless network 100, in accordance with the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some aspects, one or more components of UE 120 may be included in a housing.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

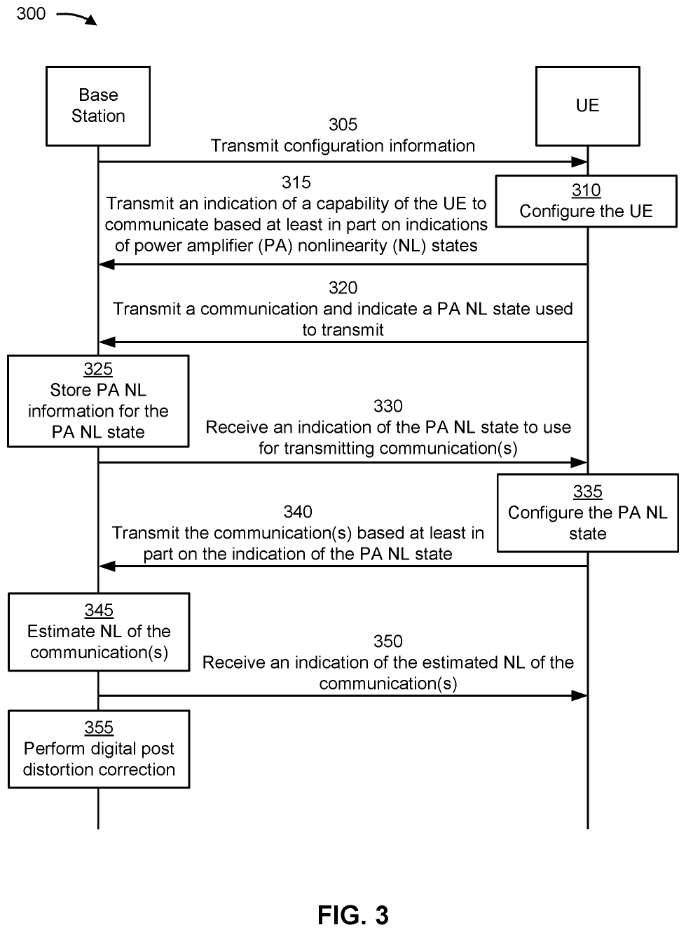

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein (for example, as described with reference to FIGS. 3-8.

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein (for example, as described with reference to FIGS. 3-8.).

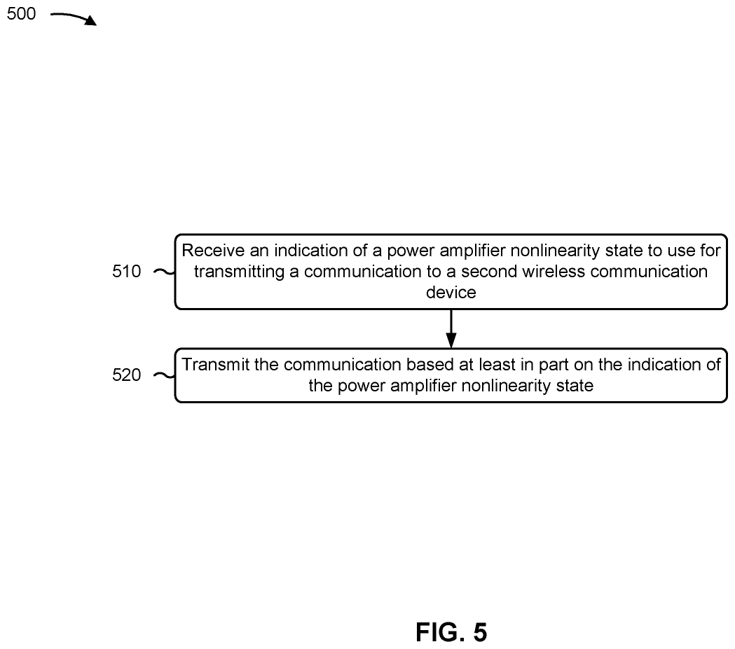

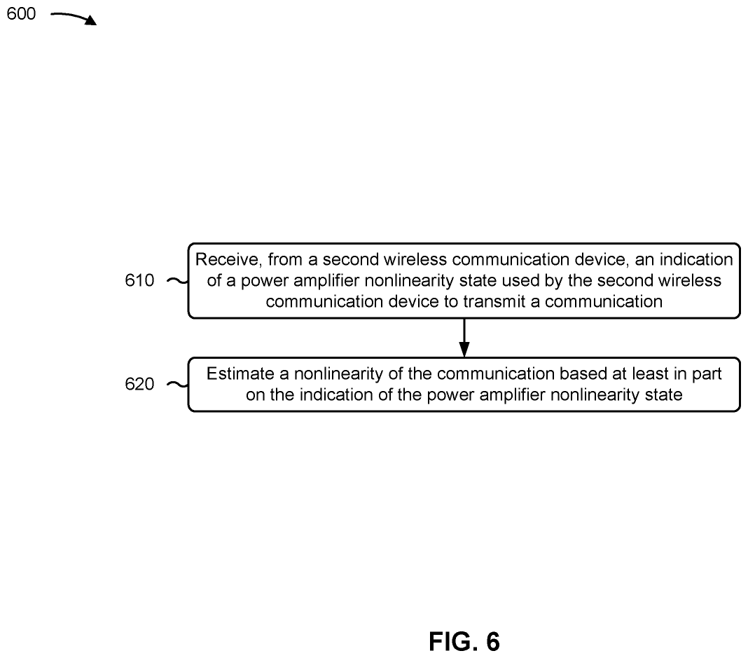

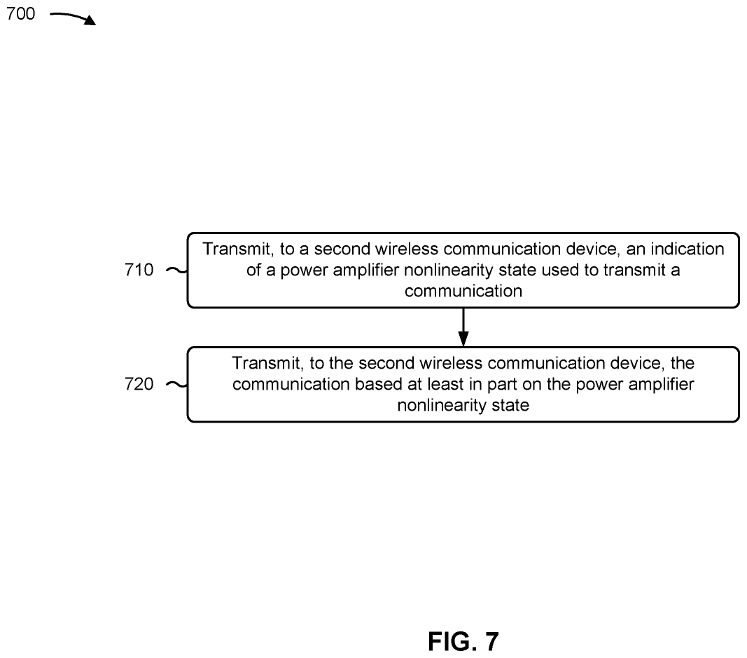

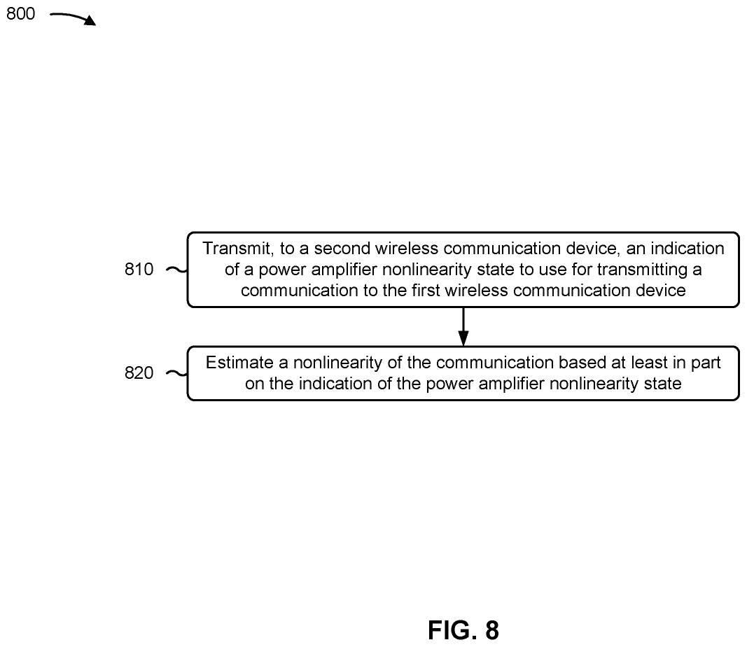

Controller/processor 240 of base station 110, controller/processor 280 of UE 120, and/or any other component(s) of FIG. 2 may perform one or more techniques associated with indications of a power amplifier nonlinearity state, as described in more detail elsewhere herein. For example, controller/processor 240 of base station 110, controller/processor 280 of UE 120, and/or any other component(s) of FIG. 2 may perform or direct operations of, for example, process 500 of FIG. 5, process 600 of FIG. 6, process 700 of FIG. 7, process 800 of FIG. 8, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 500 of FIG. 5, process 600 of FIG. 6, process 700 of FIG. 7, process 800 of FIG. 8, and/or other processes as described herein. In some aspects, executing instructions may include running the instructions, converting the instructions, compiling the instructions, and/or interpreting the instructions, among other examples.

In some aspects, a first wireless communication device (e.g., base station 110, UE 120, and/or the like) may include means for receiving an indication of a power amplifier nonlinearity state to use for transmitting a communication to a second wireless communication device, means for transmitting the communication based at least in part on the indication of the power amplifier nonlinearity state, and/or the like. In some aspects, a first wireless communication device (e.g., base station 110, UE 120, and/or the like) may include means for receiving, from a second wireless communication device, an indication of a power amplifier nonlinearity state used by the second wireless communication device to transmit a communication; means for estimating a nonlinearity of the communication based at least in part on the indication of the power amplifier nonlinearity state, and/or the like. In some aspects, such means may include one or more components of UE 120 described in connection with FIG. 2, such as controller/processor 280, transmit processor 264, TX MIMO processor 266, MOD 254, antenna 252, DEMOD 254, MIMO detector 256, receive processor 258, and/or the like.

In some aspects, first wireless communication device (e.g., base station 110, UE 120, and/or the like) may include means for transmitting, to a second wireless communication device, an indication of a power amplifier nonlinearity state used to transmit a communication; means for transmitting, to the second wireless communication device, the communication based at least in part on the power amplifier nonlinearity state; and/or the like. In some aspects, first wireless communication device (e.g., base station 110, UE 120, and/or the like) may include means for transmitting, to a second wireless communication device, an indication of a power amplifier nonlinearity state to use for transmitting a communication to the first wireless communication device; means for estimating a nonlinearity of the communication based at least in part on the indication of the power amplifier nonlinearity state; and/or the like. In some aspects, such means may include one or more components of base station 110 described in connection with FIG. 2, such as antenna 234, DEMOD 232, MIMO detector 236, receive processor 238, controller/processor 240, transmit processor 220, TX MIMO processor 230, MOD 232, antenna 234, and/or the like.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

In some wireless communication devices, such as a UE or a base station, the wireless communication device may use nonlinear components, such as high-power amplifiers with limited linear dynamic ranges. This may cause transmissions to be distorted based at least in part on a relatively high Peak-to-Average Power Ratio (PAPR). The nonlinear distortions may be classified as in-band distortion, which may affect link performance and/or out-band distortion associated with adjacent channel interference.

To reduce in-band distortion and/or out-band distortion, power back-off may be used to reduce an amount of transmission power. However, power back-off may reduce a power efficiency of transmissions. Additionally, or alternatively, the wireless communication device may use a digital pre-distorter (DPD) in a decision feedback equalizer (DFE) to reduce distortion. However, a wireless communication device having a plurality of transmission elements in each port may encounter difficulty in performing DPD per transmission element or per port of the wireless communication device.

In some networks, a receiving wireless communication device may estimate nonlinearity and/or use digital post distortion (DPOD) to reduce, or correct, an amount of distortion caused by a received transmission. In some networks, the receiving wireless communication device may estimate nonlinearity and/or perform over the air DPD training in which the receiving wireless communication device assists a transmitting wireless communication device to train a nonlinear transmission array by providing feedback (e.g., an indication of the estimated nonlinearity).

However, the receiving wireless communication device may not receive a sufficient number of pilots within transmissions from the transmitting wireless communication device to accurately (e.g., with a threshold amount of accuracy) estimate the nonlinearity. This may cause the transmitting wireless communication device to use an increased amount of power back-off to sufficiently reduce distortion caused by transmissions by the transmitting wireless communication device. This may reduce a power efficiency of the transmissions, which may decrease power efficiency and consume power resources of the transmitting wireless communication device. Transmitting with a sufficient number of pilots within transmission from the transmitting wireless communication device may consume network and/or communication resources based at least in part on an increased overhead of the transmissions.

In some aspects described herein, a receiving wireless communication device may be aware of a power amplifier nonlinearity state associated with transmissions by a transmitting wireless communication device. For example, the transmitting wireless communication device may indicate a power amplifier nonlinearity state, to the receiving wireless communication device, for one or more transmissions. In some aspects, the receiving wireless communication device may indicate a power amplifier nonlinearity state for the transmitting wireless communication device to use to transmit communications.

Based at least in part on the receiving wireless communication device being aware of a power amplifier nonlinearity state associated with transmissions by the transmitting wireless communication device, the receiving wireless communication device may use pilot measurements from previous transmissions, using a same power amplifier nonlinearity state, to estimate nonlinearity of transmitted communications by the transmitting wireless communication device. In this way, the receiving wireless communication device may accurately estimate nonlinearity of transmissions from the transmitting wireless communication device with a reduced number of pilots in individual transmitted communications. This may conserve power resources that may otherwise be lost to power inefficiencies from an increase in power back-off and/or conserve communication and network resources that may otherwise be used to transmit additional pilots.

FIG. 3 is a diagram illustrating an example 300 associated with indications of a power amplifier nonlinearity state, in accordance with the present disclosure. As shown in FIG. 3, a UE (e.g., UE 120) may communicate with a base station (e.g., base station 110). The UE and the base station may be part of a wireless network (e.g., wireless network 100).

As shown by reference number 305, the base station may transmit, and the UE may receive, configuration information. In some aspects, the UE may receive configuration information from another device (e.g., from another base station, another UE, and/or the like). In some aspects, the UE may receive the configuration information via one or more of radio resource control (RRC) signaling, medium access control (MAC) signaling (e.g., MAC control elements (MAC CEs)), and/or the like. In some aspects, the configuration information may include an indication of one or more configuration parameters (e.g., already known to the UE) for selection by the UE, explicit configuration information for the UE to use to configure the UE, and/or the like.

In some aspects, the configuration information may indicate that the UE is to provide an indication of a power amplifier nonlinearity state for one or more uplink transmissions. In some aspects, the configuration information may indicate that the UE is to transmit an indication of a capability of the UE to transmit communications based at least in part on an indication of a power amplifier nonlinearity state (e.g., received from the base station). In other words, the configuration information may include a request for capability information to indicate whether the UE is capable of using an indicated power amplifier nonlinearity state to configure the UE for transmitting a communication.

In some aspects, the power amplifier nonlinearity state may be based at least in part on, or may identify, one or more metrics, such as a transmission port, a transmission beam, a power amplifier gain state, a power amplifier supply voltage state (VCC), and/or the like that used to transmit a communication. In some aspects, the UE may be configured to use a configured number of different power amplifier nonlinearity states for transmitting. The different power amplifier nonlinearity states may be associated with respective identifiers (e.g., indices) that can be used to identify a set of metrics.

In some aspects, the configuration information may indicate that the UE is to transmit communications with an indicated power amplifier nonlinearity state for a single transmission, a specified number of transmissions, a set of transmissions scheduled by a configured grant, transmissions within a specified time period, transmissions associated with one or more channels, transmissions until receipt of an indication to change from the indicated power amplifier nonlinearity state, and/or the like.

As shown by reference number 310, the UE may configure the UE for communicating with the base station. In some aspects, the UE may configure the UE based at least in part on the configuration information. In some aspects, the UE may be configured to perform one or more operations described herein.

As shown by reference number 315, the UE may transmit, and the base station may receive, an indication of a capability of the UE to communicate based at least in part on an indication of a power amplifier nonlinearity state. For example, the UE may indicate a capability of the UE to freeze (e.g., prohibit changing) a power amplifier nonlinearity state based at least in part on receiving an indication to freeze the power amplifier nonlinearity state. In some aspects, the UE may indicate a capability to identify a set of parameters for transmitting communications based at least in part on an indication from the base station (e.g., an indication of an identifier associated with a set of parameters). In some aspects, the UE may transmit the indication via RRC signaling, one or more MAC CEs, a physical uplink control channel (PUCCH) message, and/or the like.

As shown by reference number 320, the UE may transmit, and the base station may receive, one or more communications, and indicate power amplifier nonlinearity states used to transmit respective communications of the one or more communications. In some aspects, the UE may transmit one or more pilots within the one or more communications that may be used to estimate nonlinearities associated with different power amplifier nonlinearity states. In some aspects, individual transmissions may have an insufficient number of pilots to accurately (e.g., with an accuracy that satisfies a threshold) estimate a nonlinearity for the individual transmission.

In some aspects, combining (e.g., aggregating, averaging, and/or the like) a set of the one or more communications may provide a sufficient number of pilots to accurately estimate the nonlinearity for the set of the one or more communications. Based at least in part on indicating the power amplifier nonlinearity states used to transmit the one or more communications, a receiving device (e.g., the base station) may be able to combine a set of the one or more communications that were transmitted with a same power amplifier nonlinearity state to estimate a nonlinearity of communications transmitted with the same power amplifier nonlinearity state.

As shown by reference number 325, the base station may store power amplifier nonlinearity information for the power amplifier nonlinearity state. For example, the base station may store information (e.g., information from pilots) from respective communications from the UE and may identify the information based at least in part on the indicated power amplifier nonlinearity state. In this way, the base station may be capable of averaging the stored information for one or more of the power amplifier nonlinearity states to estimate nonlinearities of the power amplifier nonlinearity states.

As shown by reference number 330, the UE may receive, and the base station may transmit, an indication of a power amplifier nonlinearity state to use for transmitting one or more communications. In some aspects, the indication of the power amplifier nonlinearity state may include a power amplifier (PA) transmission configuration indicator (TCI) state. The PA TCI state may be identified in a quasi co-location (QCL) type indicator.

In some aspects, the UE may receive the indication of the power amplifier nonlinearity state via a downlink control information (DCI) message (e.g., a dynamic indicator), a sidelink control information (SCI) message (e.g., a dynamic indicator from another UE), RRC signaling (e.g., a higher layer indicator, a configured grant, and/or the like), one or more MAC CEs, and/or the like.

In some aspects, the indication may include one or more indications associated with respective channels. For example, the indication may include a first indication for a power amplifier nonlinearity state for a PUCCH, a second indication for a physical uplink shared channel (PUSCH), and/or the like.

In some aspects, the indication of the power amplifier nonlinearity state may include an identification of the power amplifier nonlinearity state to use for transmitting the communication, an indication to use a same set of power amplifier parameters for a series of transmitted communications, a threshold amount of allowable modifications to a set of power amplifier parameters for a series of transmitted communications, and/or the like. For example, the indication of the power amplifier nonlinearity state may indicate that the UE is allowed to make a modification to the set of power amplifier parameters as long as a change to the power amplifier nonlinearity state satisfies (e.g., is below) a threshold.

In some aspects, the series of transmitted communications include the transmission of the communication and one or more transmissions of previous communications, one or more transmissions of subsequent communications, and/or the like. In some aspects, the indication of the power amplifier nonlinearity state may be applied to, based at least in part on an indication and/or configuration information, a number of transmissions to include in the series of transmitted communications, an amount of time in which transmissions are to be included in the series of transmitted communications, all transmissions for one or more channels until reception of an additional indication of the power amplifier nonlinearity state, and/or the like.

In some aspects, the indication of the power amplifier nonlinearity state indicates to determine a transmission power for respective transmissions of a series of communications based at least in part on a same pathloss measurement. In other words, the UE may derive parameters for the respective transmissions of the series (e.g., a series indicated by the base station) based at least in part on a same reference signal (e.g., a pathloss reference signal).

As shown by reference number 335, the UE may configure the power amplifier nonlinearity state for transmitting the one or more communications. In some aspects, the UE may configure one or more components of a transmission chain (e.g., a transmit port, a transmit processor, a TX MIMO processor 266, a power amplifier, one or more antennas 252, and/or the like) based at least in part on the indication of the power amplifier nonlinearity state. In some aspects, the UE may configure a transmission port used to transmit the communication, a transmission beam used to transmit the communication, a power amplifier gain state used to transmit the communication, a power amplifier supply voltage state used to transmit the communication, and/or the like. In some aspects, based at least in part on the indication of the power amplifier nonlinearity state, the UE may use a same configuration used to transmit a previous communication (e.g., an immediately preceding communication, a previous communication identified by a power amplifier nonlinearity state identifier, and/or the like).

As shown by reference number 340, the UE may transmit, and the base station may receive, the one or more communications based at least in part on the indication of the power amplifier nonlinearity state. In some aspects, the UE may transmit the one or more communications with or without any pilots, with or without sufficient pilots to accurately estimate nonlinearity, and/or the like.

As shown by reference number 345, the base station may estimate nonlinearity of the one or more communications. In some aspects, the base station may estimate the nonlinearity of the one or more communications (e.g., a combined nonlinearity, respective nonlinearities, and/or the like) based at least in part on pilot measurements of one or more additional communications transmitted by the UE. For example, the base station may estimate the nonlinearity based at least in part on combining (e.g., aggregating, averaging, and/or the like) measurements of pilots from one or more previous communications having a same power amplifier nonlinearity state, a power amplifier nonlinearity state that is modified within a threshold amount from the one or more communications, and/or the like.

As shown by reference number 350, the base station may transmit an indication of the estimated nonlinearity of the one or more communications. In some aspects, the indication of the estimated nonlinearity may identify a power amplifier nonlinearity state associated with the estimated nonlinearity. In some aspects, the indication of the estimated nonlinearity may indicate a power amplifier nonlinearity state with a smallest amount of nonlinearity. In some aspects, the indication of the estimated nonlinearity may provide estimated nonlinearity for multiple power amplifier nonlinearity states (e.g., as a report). In some aspects, the indication of the estimated nonlinearity may enable the UE to perform digital predistortion for subsequent transmissions using a same port as the power amplifier nonlinearity state.

As shown by reference number 355, the base station may perform digital post distortion correction based at least in part on the estimated nonlinearity of the one or more communications.

Based at least in part on the base station being aware of a power amplifier nonlinearity state associated with transmissions by the UE, the base station may use pilot measurements from previous transmissions, using a same power amplifier nonlinearity state, to estimate nonlinearity of transmitted communications by the UE. In this way, the base station may accurately estimate nonlinearity of transmissions from the UE with a reduced number of pilots in individual transmitted communications. This may conserve power resources that may otherwise be lost to power inefficiencies from an increase in power back-off and/or conserve communication and network resources that may otherwise be used to transmit additional pilots.

As indicated above, FIG. 3 is provided as an example. Other examples may differ from what is described with respect to FIG. 3.

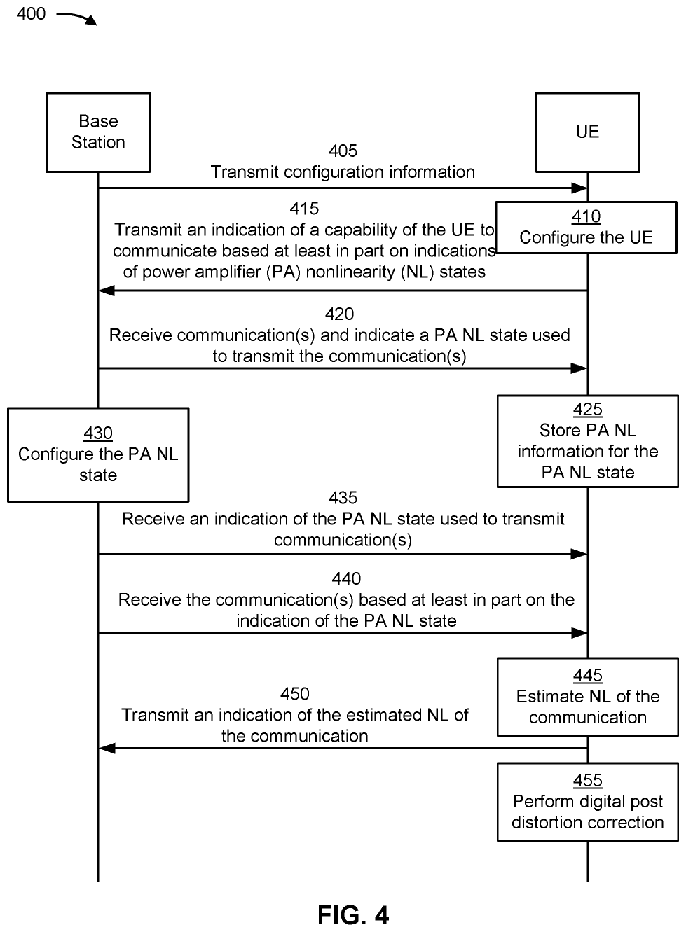

FIG. 4 is a diagram illustrating an example 400 associated with indications of a power amplifier nonlinearity state, in accordance with the present disclosure. As shown in FIG. 4, a UE (e.g., UE 120) may communicate with a base station (e.g., base station 110). The UE and the base station may be part of a wireless network (e.g., wireless network 100).

As shown by reference number 405, the base station may transmit, and the UE may receive, configuration information. In some aspects, the UE may receive configuration information from another device (e.g., from another base station, another UE, and/or the like). In some aspects, the UE may receive the configuration information via one or more of RRC signaling, MAC signaling (e.g., MAC CEs), and/or the like. In some aspects, the configuration information may include an indication of one or more configuration parameters (e.g., already known to the UE) for selection by the UE, explicit configuration information for the UE to use to configure the UE, and/or the like.

In some aspects, the configuration information may indicate that the UE is to estimate a nonlinearity of one or more downlink transmissions based at least in part on indicated power amplifier nonlinearity states of the one or more downlink transmission. For example, the configuration information may indicate that the UE is to store power amplifier nonlinearity state information for one or more power amplifier nonlinearity states used by the base station to transmit a downlink communication. In some aspects, the configuration information may indicate that the UE is to transmit an indication of a capability of the UE to estimate nonlinearity based at least in part on a power amplifier nonlinearity state, based at least in part on combining power amplifier nonlinearity state information for multiple downlink transmissions, and/or the like.

In some aspects, the configuration information may indicate that the UE is to receive communications with an indicated power amplifier nonlinearity state for a single transmission, a specified number of transmissions, a set of transmissions scheduled by a configured grant, transmissions within a specified time period, transmissions associated with one or more channels, transmissions until receipt of an indication to change from the indicated power amplifier nonlinearity state, and/or the like.

As shown by reference number 410, the UE may configure the UE for communicating with the base station. In some aspects, the UE may configure the UE based at least in part on the configuration information. In some aspects, the UE may be configured to perform one or more operations described herein.

As shown by reference number 415, the UE may transmit, and the base station may receive, an indication of a capability of the UE to communicate based at least in part on an indication of a power amplifier nonlinearity state. For example, the UE may indicate a capability of the UE to combine pilot measurements for multiple downlink transmissions based at least in part on an indicated power amplifier nonlinearity state. In some aspects, the UE may transmit the indication via RRC signaling, one or more MAC CEs, a PUCCH message, and/or the like.

As shown by reference number 420, the UE may receive, and the base station may transmit, one or more communications with an indication of a power amplifier nonlinearity state used to transmit respective communications of the one or more communications. In some aspects, the base station may transmit one or more pilots within the one or more communications that may be used by the UE to estimate nonlinearities associated with different power amplifier nonlinearity states. In some aspects, individual transmissions may have an insufficient number of pilots for the UE to accurately (e.g., with an accuracy that satisfies a threshold) estimate a nonlinearity for the individual transmission.

Based at least in part on indications of the power amplifier nonlinearity states used to transmit the one or more communications, the UE may be able to combine a set of the one or more communications that were transmitted with a same power amplifier nonlinearity state to estimate a nonlinearity of communications transmitted with the same power amplifier nonlinearity state.

As shown by reference number 425, the UE may store power amplifier nonlinearity information for the power amplifier nonlinearity state. For example, the UE may store information (e.g., information from pilots) from respective communications from the base station and may identify the information based at least in part on the indicated power amplifier nonlinearity state. In this way, the UE may be capable of averaging the stored information for one or more of the power amplifier nonlinearity states to estimate nonlinearities of the power amplifier nonlinearity states.

As shown by reference number 430, the base station may configure the power amplifier nonlinearity state for transmitting the one or more communications. In some aspects, the base station may configure one or more components of a transmission chain (e.g., a transmit port, a transmit processor, a TX MIMO processor 230, a power amplifier, one or more antennas 234, and/or the like) based at least in part on the power amplifier nonlinearity state. In some aspects, the base station may configure a transmission port used to transmit the communication, a transmission beam used to transmit the communication, a power amplifier gain state used to transmit the communication, a power amplifier supply voltage state used to transmit the communication, and/or the like. In some aspects, based at least in part on the power amplifier nonlinearity state, the base station may use a same configuration used to transmit a previous communication (e.g., an immediately preceding communication, a previous communication identified by a power amplifier nonlinearity state identifier, and/or the like).

As shown by reference number 435, the UE may receive, and the base station may transmit, an indication of a power amplifier nonlinearity state used to transmit one or more communications (e.g. one or more previous, current, or subsequent transmitted communications). In some aspects, the indication of the power amplifier nonlinearity state may include a PA TCI state. The PA TCI state may be identified in a QCL type indicator.

In some aspects, the UE may receive the indication of the power amplifier nonlinearity state via a DCI message (e.g., a dynamic indicator), an SCI message (e.g., a dynamic indicator from another UE), RRC signaling (e.g., a higher layer indicator, a configured grant, and/or the like), one or more MAC CEs, and/or the like.

In some aspects, the indication may include one or more indications associated with respective channels. For example, the indication may include a first indication for a power amplifier nonlinearity state for a physical downlink control channel (PDCCH), a second indication for a physical downlink shared channel (PDSCH), and/or the like.

In some aspects, the indication of the power amplifier nonlinearity state may include an identification of the power amplifier nonlinearity state used for transmitting the communication, an indication that a same set of power amplifier parameters are used for a series of transmitted communications, an indication of an amount (e.g., an indication that a threshold amount is satisfied (e.g., an amount is less than the threshold)) of modifications to a set of power amplifier parameters, from a previously transmitted communication, to be applied to a transmission of the communication, and/or the like.

In some aspects, the series of transmitted communications may include the transmission of the communication and one or more transmissions of previous communications, one or more transmissions of subsequent communications, and/or the like. In some aspects, the indication of the power amplifier nonlinearity state may be applied to, based at least in part on an indication and/or configuration information, a number of transmissions to include in the series of transmitted communications, an amount of time in which transmissions are to be included in the series of transmitted communications, all transmissions for one or more channels until reception of an additional indication of the power amplifier nonlinearity state, and/or the like.

As shown by reference number 440, the UE may receive, and the base station may transmit, the one or more communications based at least in part on the indication of the power amplifier nonlinearity state. In some aspects, the base station may transmit the one or more communications with or without any pilots, with or without sufficient pilots to accurately estimate nonlinearity, and/or the like.

As shown by reference number 445, the UE may estimate nonlinearity of the one or more communications. In some aspects, the UE may estimate the nonlinearity of the one or more communications (e.g., a combined nonlinearity, respective nonlinearities, and/or the like) based at least in part on pilot measurements of one or more additional communications transmitted by the base station. For example, the UE may estimate the nonlinearity based at least in part on combining (e.g., aggregating, averaging, and/or the like) measurements of pilots from one or more previous communications having a same power amplifier nonlinearity state, a power amplifier nonlinearity state that is modified within a threshold amount from the one or more communications, and/or the like.

As shown by reference number 450, the UE may transmit an indication of the estimated nonlinearity of the one or more communications. In some aspects, the indication of the estimated nonlinearity may identify a power amplifier nonlinearity state associated with the estimated nonlinearity. In some aspects, the indication of the estimated nonlinearity may indicate a power amplifier nonlinearity state with a smallest amount of nonlinearity. In some aspects, the indication of the estimated nonlinearity may provide estimated nonlinearity for multiple power amplifier nonlinearity states (e.g., as a report). In some aspects, the indication of the estimated nonlinearity may enable the base station to perform digital predistortion for subsequent transmissions using a same port as the power amplifier nonlinearity state.

As shown by reference number 455, the UE may perform digital post distortion correction based at least in part on the estimated nonlinearity of the one or more communications.

Based at least in part on the UE being aware of a power amplifier nonlinearity state associated with transmissions by the base station, the UE may use pilot measurements from previous transmissions, using a same power amplifier nonlinearity state, to estimate nonlinearity of transmitted communications by the base station. In this way, the UE may accurately estimate nonlinearity of transmissions from the base station with a reduced number of pilots in individual transmitted communications. This may conserve power resources that may otherwise be lost to power inefficiencies from an increase in power back-off and/or conserve communication and network resources that may otherwise be used to transmit additional pilots.

As indicated above, FIG. 4 is provided as an example. Other examples may differ from what is described with respect to FIG. 4.

FIG. 5 is a diagram illustrating an example process 500 performed, for example, by a first wireless communication device, in accordance with the present disclosure. Example process 500 is an example where the first wireless communication device (e.g., base station 110, UE 120, and/or the like) performs operations associated with indications of a power amplifier nonlinearity state.

As shown in FIG. 5, in some aspects, process 500 may include receiving an indication of a power amplifier nonlinearity state to use for transmitting a communication to a second wireless communication device (block 510). For example, the first wireless communication device (e.g., using antenna 234, DEMOD 232, MIMO detector 236, receive processor 238, controller/processor 240, antenna 252, DEMOD 254, MIMO detector 256, receive processor 258, controller/processor 280, and/or the like) may receive an indication of a power amplifier nonlinearity state to use for transmitting a communication to a second wireless communication device, as described above.

As further shown in FIG. 5, in some aspects, process 500 may include transmitting the communication based at least in part on the indication of the power amplifier nonlinearity state (block 520). For example, the first wireless communication device (e.g., using controller/processor 240, transmit processor 220, TX MIMO processor 230, MOD 232, antenna 234, controller/processor 280, transmit processor 264, TX MIMO processor 266, MOD 254, antenna 252, and/or the like) may transmit the communication based at least in part on the indication of the power amplifier nonlinearity state, as described above.

Process 500 may include additional aspects, such as any single aspect or any combination of aspects described below and/or in connection with one or more other processes described elsewhere herein.

In a first aspect, the indication of the power amplifier nonlinearity state includes one or more of an identification of the power amplifier nonlinearity state to use for transmitting the communication, an indication to use a same set of power amplifier parameters for a series of transmitted communications, or a threshold amount of allowable modifications to a set of power amplifier parameters for a series of transmitted communications.

In a second aspect, alone or in combination with the first aspect, the series of transmitted communications includes a transmission of the communication, and one or more of a transmission of a previous communication, or a transmission of a subsequent communication.

In a third aspect, alone or in combination with one or more of the first and second aspects, the indication of the power amplifier nonlinearity state is to be applied to the series of transmitted communications based at least in part on one or more of an indicated number of transmissions to include in the series of transmitted communications, a configured number of transmissions to include in the series of transmitted communications, an indicated amount of time in which transmissions are to be included in the series of transmitted communications, a configured amount of time in which transmissions are to be included in the series of transmitted communications, or all transmissions for one or more channels until reception of an additional indication of the power amplifier nonlinearity state.

In a fourth aspect, alone or in combination with one or more of the first through third aspects, the indication of the power amplifier nonlinearity state indicates to use a same set of power amplifier parameters for a series of transmitted communications, and process 500 further includes determining a transmission power for respective transmissions of the series of transmitted communications based at least in part on a same pathloss measurement.

In a fifth aspect, alone or in combination with one or more of the first through fourth aspects, the power amplifier nonlinearity state includes a power amplifier transmission configuration indicator state.

In a sixth aspect, alone or in combination with one or more of the first through fifth aspects, receiving the indication of the power amplifier nonlinearity state includes receiving the indication of the power amplifier nonlinearity state via one or more of a DCI message, an SCI message, RRC signaling, or one or more MAC CEs.

In a seventh aspect, alone or in combination with one or more of the first through sixth aspects, the indication of the power amplifier nonlinearity state includes one or more of a first indication of a first power amplifier state for a first channel, or a second indication of a second power amplifier state for a second channel.

In an eighth aspect, alone or in combination with one or more of the first through seventh aspects, the power amplifier nonlinearity state is based at least in part on one or more of a transmission port used to transmit the communication, a transmission beam used to transmit the communication, a power amplifier gain state used to transmit the communication, or a power amplifier supply voltage state used to transmit the communication.

In a ninth aspect, alone or in combination with one or more of the first through eighth aspects, process 500 includes transmitting an indication of a capability of the first wireless communication device to transmit the communication based at least in part on the indication of the power amplifier nonlinearity state.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, by a first wireless communication device, in accordance with the present disclosure. Example process 600 is an example where the first wireless communication device (e.g., base station 110, UE 120, and/or the like) performs operations associated with indications of a power amplifier nonlinearity state.

As shown in FIG. 6, in some aspects, process 600 may include receiving, from a second wireless communication device, an indication of a power amplifier nonlinearity state used by the second wireless communication device to transmit a communication (block 610). For example, the first wireless communication device (e.g., using antenna 234, DEMOD 232, MIMO detector 236, receive processor 238, controller/processor 240, antenna 252, DEMOD 254, MIMO detector 256, receive processor 258, controller/processor 280, and/or the like) may receive, from a second wireless communication device, an indication of a power amplifier nonlinearity state used by the second wireless communication device to transmit a communication, as described above.

As further shown in FIG. 6, in some aspects, process 600 may include estimating a nonlinearity of the communication based at least in part on the indication of the power amplifier nonlinearity state (block 620). For example, the first wireless communication device (e.g., using antenna 234, DEMOD 232, MIMO detector 236, receive processor 238, controller/processor 240, antenna 252, DEMOD 254, MIMO detector 256, receive processor 258, controller/processor 280, and/or the like) may estimate a nonlinearity of the communication based at least in part on the indication of the power amplifier nonlinearity state, as described above.

Process 600 may include additional aspects, such as any single aspect or any combination of aspects described below and/or in connection with one or more other processes described elsewhere herein.

In a first aspect, process 600 includes performing digital post distortion correction for the communication based at least in part on estimating the nonlinearity of the communication, or transmitting, to the second wireless communication device, an indication of an estimated nonlinearity of the communication.

In a second aspect, alone or in combination with the first aspect, estimating the nonlinearity of the communication based at least in part on the indication of the power amplifier nonlinearity state includes estimating the nonlinearity based at least in part on pilot measurements of one or more additional communications transmitted by the second wireless communication device.

In a third aspect, alone or in combination with one or more of the first and second aspects, the indication of the power amplifier nonlinearity state includes one or more of an identification of the power amplifier nonlinearity state used to transmit the communication, an indication that a same set of power amplifier parameters is used for a series of transmitted communications, or an indication of an amount of modifications to a set of power amplifier parameters, from a previously transmitted communication, to be applied to a transmission of the communication.

In a fourth aspect, alone or in combination with one or more of the first through third aspects, the series of transmitted communications includes a transmission of the communication, and one or more of a transmission of a previous communication, or a transmission of a subsequent communication.

In a fifth aspect, alone or in combination with one or more of the first through fourth aspects, the indication of the power amplifier nonlinearity state is to be applied to the series of transmitted communications based at least in part on one or more of an indicated number of transmissions to include in the series of transmitted communications, a configured number of transmissions to include in the series of transmitted communications, an indicated amount of time in which transmissions are to be included in the series of transmitted communications, a configured amount of time in which transmissions are to be included in the series of transmitted communications, or all transmissions for one or more channels until reception of an additional indication of the power amplifier nonlinearity state.

In a sixth aspect, alone or in combination with one or more of the first through fifth aspects, the power amplifier nonlinearity state includes a power amplifier transmission configuration indicator state.

In a seventh aspect, alone or in combination with one or more of the first through sixth aspects, receiving the indication of the power amplifier nonlinearity state includes receiving the indication of the power amplifier nonlinearity state via one or more of a DCI message, an SCI message, RRC signaling, or one or more MAC CEs.

In an eighth aspect, alone or in combination with one or more of the first through seventh aspects, the indication of the power amplifier nonlinearity state includes one or more of a first indication of a first power amplifier state for a first channel, or a second indication of a second power amplifier state for a second channel.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a first wireless communication device, in accordance with the present disclosure. Example process 700 is an example where the first wireless communication device (e.g., base station 110, UE 120, and/or the like) performs operations associated with indications of a power amplifier nonlinearity state.

As shown in FIG. 7, in some aspects, process 700 may include transmitting, to a second wireless communication device, an indication of a power amplifier nonlinearity state used to transmit a communication (block 710). For example, the first wireless communication device (e.g., using controller/processor 240, transmit processor 220, TX MIMO processor 230, MOD 232, antenna 234, controller/processor 280, transmit processor 264, TX MIMO processor 266, MOD 254, antenna 252, and/or the like) may transmit, to a second wireless communication device, an indication of a power amplifier nonlinearity state used to transmit a communication, as described above.

As further shown in FIG. 7, in some aspects, process 700 may include transmitting, to the second wireless communication device, the communication based at least in part on the power amplifier nonlinearity state (block 720). For example, the first wireless communication device (e.g., using controller/processor 240, transmit processor 220, TX MIMO processor 230, MOD 232, antenna 234, controller/processor 280, transmit processor 264, TX MIMO processor 266, MOD 254, antenna 252, and/or the like) may transmit, to the second wireless communication device, the communication based at least in part on the power amplifier nonlinearity state, as described above.

Process 700 may include additional aspects, such as any single aspect or any combination of aspects described below and/or in connection with one or more other processes described elsewhere herein.

In a first aspect, process 700 includes receiving an indication of an estimated nonlinearity of a transmission port used to transmit the communication, wherein the estimated nonlinearity of the transmission port is being based at least in part on the indication of the power amplifier nonlinearity state.

In a second aspect, alone or in combination with the first aspect, the indication of the power amplifier nonlinearity state includes one or more of an identification of the power amplifier nonlinearity state used to transmit the communication, an indication that a same set of power amplifier parameters is used for a series of transmitted communications, or an indication of an amount of modifications to a set of power amplifier parameters, from a previously transmitted communication, to be applied to a transmission of the communication.

In a third aspect, alone or in combination with one or more of the first and second aspects, the series of transmitted communications includes a transmission of the communication, and one or more of a transmission of a previous communication, or a transmission of a subsequent communication.

In a fourth aspect, alone or in combination with one or more of the first through third aspects, the indication of the power amplifier nonlinearity state is to be applied to the series of transmitted communications based at least in part on one or more of an indicated number of transmissions to include in the series of transmitted communications, a configured number of transmissions to include in the series of transmitted communications, an indicated amount of time in which transmissions are to be included in the series of transmitted communications, a configured amount of time in which transmissions are to be included in the series of transmitted communications, or all transmissions for one or more channels until reception of an additional indication of the power amplifier nonlinearity state.

In a fifth aspect, alone or in combination with one or more of the first through fourth aspects, the power amplifier nonlinearity state includes a power amplifier transmission configuration indicator state.

In a sixth aspect, alone or in combination with one or more of the first through fifth aspects, transmitting the indication of the power amplifier nonlinearity state includes transmitting the indication of the power amplifier nonlinearity state via one or more of a DCI message, an SCI message, RRC signaling, or one or more MAC CEs.

In a seventh aspect, alone or in combination with one or more of the first through sixth aspects, the indication of the power amplifier nonlinearity state includes one or more of a first indication of a first power amplifier state for a first channel, or a second indication of a second power amplifier state for a second channel.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a first wireless communication device, in accordance with the present disclosure. Example process 800 is an example where the first wireless communication device (e.g., base station 110, UE 120, and/or the like) performs operations associated with indications of a power amplifier nonlinearity state.

As shown in FIG. 8, in some aspects, process 800 may include transmitting, to a second wireless communication device, an indication of a power amplifier nonlinearity state to use for transmitting a communication to the first wireless communication device (block 810). For example, the first wireless communication device (e.g., using controller/processor 240, transmit processor 220, TX MIMO processor 230, MOD 232, antenna 234, controller/processor 280, transmit processor 264, TX MIMO processor 266, MOD 254, antenna 252, and/or the like) may transmit, to a second wireless communication device, an indication of a power amplifier nonlinearity state to use for transmitting a communication to the first wireless communication device, as described above.

As further shown in FIG. 8, in some aspects, process 800 may include estimating a nonlinearity of the communication based at least in part on the indication of the power amplifier nonlinearity state (block 820). For example, the first wireless communication device (e.g., using antenna 234, DEMOD 232, MIMO detector 236, receive processor 238, controller/processor 240, antenna 252, DEMOD 254, MIMO detector 256, receive processor 258, controller/processor 280, and/or the like) may estimate a nonlinearity of the communication based at least in part on the indication of the power amplifier nonlinearity state, as described above.

Process 800 may include additional aspects, such as any single aspect or any combination of aspects described below and/or in connection with one or more other processes described elsewhere herein.

In a first aspect, process 800 includes performing digital post distortion correction for the communication based at least in part on estimating the nonlinearity of the communication, or transmitting, to the second wireless communication device, an indication of an estimated nonlinearity of the communication.

In a second aspect, alone or in combination with the first aspect, estimating the nonlinearity of the communication based at least in part on the indication of the power amplifier nonlinearity state includes estimating the nonlinearity based at least in part on pilot measurements of one or more additional communications transmitted by the second wireless communication device.

In a third aspect, alone or in combination with one or more of the first and second aspects, the indication of the power amplifier nonlinearity state includes one or more of an identification of the power amplifier nonlinearity state to use for transmitting the communication, an indication to use a same set of power amplifier parameters for a series of transmitted communications, or a threshold amount of allowable modifications to a set of power amplifier parameters for a series of transmitted communications.

In a fourth aspect, alone or in combination with one or more of the first through third aspects, the series of transmitted communications includes a transmission of the communication, and one or more of a transmission of a previous communication, or a transmission of a subsequent communication.

In a fifth aspect, alone or in combination with one or more of the first through fourth aspects, the indication of the power amplifier nonlinearity state is to be applied to the series of transmitted communications based at least in part on one or more of an indicated number of transmissions to include in the series of transmitted communications, a configured number of transmissions to include in the series of transmitted communications, an indicated amount of time in which transmissions are to be included in the series of transmitted communications, a configured amount of time in which transmissions are to be included in the series of transmitted communications, or all transmissions for one or more channels until reception of an additional indication of the power amplifier nonlinearity state.

In a sixth aspect, alone or in combination with one or more of the first through fifth aspects, the power amplifier nonlinearity state includes a power amplifier transmission configuration indicator state.

In a seventh aspect, alone or in combination with one or more of the first through sixth aspects, transmitting the indication of the power amplifier nonlinearity state includes transmitting the indication of the power amplifier nonlinearity state via one or more of a DCI message, an SCI message, RRC signaling, or one or more MAC CEs.

In an eighth aspect, alone or in combination with one or more of the first through seventh aspects, the indication of the power amplifier nonlinearity state includes one or more of a first indication of a first power amplifier state for a first channel, or a second indication of a second power amplifier state for a second channel.

In a ninth aspect, alone or in combination with one or more of the first through eighth aspects, the power amplifier nonlinearity state is based at least in part on one or more of a transmission port used to transmit the communication, a transmission beam used to transmit the communication, a power amplifier gain state used to transmit the communication, or a power amplifier supply voltage state used to transmit the communication.

In a tenth aspect, alone or in combination with one or more of the first through ninth aspects, process 800 includes receiving an indication of a capability of the second wireless communication device to transmit the communication based at least in part on the indication of the power amplifier nonlinearity state.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

The following provides an overview of some Aspects of the present disclosure:

Aspect 1: A method of wireless communication performed by a first wireless communication device, comprising: receiving an indication of a power amplifier nonlinearity state to use for transmitting a communication to a second wireless communication device; and transmitting the communication based at least in part on the indication of the power amplifier nonlinearity state.

Aspect 2: The method of Aspect 1, wherein the indication of the power amplifier nonlinearity state comprises one or more of: an identification of the power amplifier nonlinearity state to use for transmitting the communication, an indication to use a same set of power amplifier parameters for a series of transmitted communications, or a threshold amount of allowable modifications to a set of power amplifier parameters for a series of transmitted communications.

Aspect 3: The method of any of Aspects 2-3, wherein the series of transmitted communications comprises: a transmission of the communication, and one or more of: a transmission of a previous communication, or a transmission of a subsequent communication.

Aspect 4: The method of any of Aspects 2-4, wherein the indication of the power amplifier nonlinearity state is to be applied to the series of transmitted communications based at least in part on one or more of: an indicated number of transmissions to include in the series of transmitted communications, a configured number of transmissions to include in the series of transmitted communications, an indicated amount of time in which transmissions are to be included in the series of transmitted communications, a configured amount of time in which transmissions are to be included in the series of transmitted communications, or all transmissions for one or more channels until reception of an additional indication of the power amplifier nonlinearity state.

Aspect 5: The method of any of Aspects 1-4, wherein the indication of the power amplifier nonlinearity state indicates to use a same set of power amplifier parameters for a series of transmitted communications, and wherein the method further comprises determining a transmission power for respective transmissions of the series of transmitted communications based at least in part on a same pathloss measurement.

Aspect 6: The method of any of Aspects 1-5, wherein the power amplifier nonlinearity state comprises a power amplifier transmission configuration indicator state.

Aspect 7: The method of any of Aspects 1-6, wherein receiving the indication of the power amplifier nonlinearity state comprises: receiving the indication of the power amplifier nonlinearity state via one or more of: a downlink control information message, a sidelink control information message, radio resource control signaling, or one or more medium access control control elements.

Aspect 8: The method of any of Aspects 1-7, wherein the indication of the power amplifier nonlinearity state includes one or more of: a first indication of a first power amplifier state for a first channel, or a second indication of a second power amplifier state for a second channel.

Aspect 9: The method of any of Aspects 1-8, wherein the power amplifier nonlinearity state is based at least in part on one or more of: a transmission port used to transmit the communication, a transmission beam used to transmit the communication, a power amplifier gain state used to transmit the communication, or a power amplifier supply voltage state used to transmit the communication.

Aspect 10: The method of any of Aspects 1-9, further comprising: transmitting an indication of a capability of the first wireless communication device to transmit the communication based at least in part on the indication of the power amplifier nonlinearity state.

Aspect 11: A method of wireless communication performed by a first wireless communication device, comprising: receiving, from a second wireless communication device, an indication of a power amplifier nonlinearity state used by the second wireless communication device to transmit a communication; and estimating a nonlinearity of the communication based at least in part on the indication of the power amplifier nonlinearity state.

Aspect 12: The method of Aspect 11, further comprising one or more of: performing digital post distortion correction for the communication based at least in part on estimating the nonlinearity of the communication; or transmitting, to the second wireless communication device, an indication of an estimated nonlinearity of the communication.

Aspect 13: The method of any of Aspects 11-12, wherein estimating the nonlinearity of the communication based at least in part on the indication of the power amplifier nonlinearity state comprises: estimating the nonlinearity based at least in part on pilot measurements of one or more additional communications transmitted by the second wireless communication device.

Aspect 14: The method of any of Aspects 11-13, wherein the indication of the power amplifier nonlinearity state comprises one or more of: an identification of the power amplifier nonlinearity state used to transmit the communication, an indication that a same set of power amplifier parameters is used for a series of transmitted communications, or an indication of an amount of modifications to a set of power amplifier parameters, from a previously transmitted communication, to be applied to a transmission of the communication.

Aspect 15: The method of Aspect 14, wherein the series of transmitted communications comprises: a transmission of the communication, and one or more of: a transmission of a previous communication, or a transmission of a subsequent communication.

Aspect 16: The method of any of Aspects 14-15, wherein the indication of the power amplifier nonlinearity state is to be applied to the series of transmitted communications based at least in part on one or more of: an indicated number of transmissions to include in the series of transmitted communications, a configured number of transmissions to include in the series of transmitted communications, an indicated amount of time in which transmissions are to be included in the series of transmitted communications, a configured amount of time in which transmissions are to be included in the series of transmitted communications, or all transmissions for one or more channels until reception of an additional indication of the power amplifier nonlinearity state.

Aspect 17: The method of any of Aspects 11-16, wherein the power amplifier nonlinearity state comprises a power amplifier transmission configuration indicator state.

Aspect 18: The method of any of Aspects 11-17, wherein receiving the indication of the power amplifier nonlinearity state comprises: receiving the indication of the power amplifier nonlinearity state via one or more of: a downlink control information message, a sidelink control information message, radio resource control signaling, or one or more medium access control control elements.

Aspect 19: The method of any of Aspects 11-18, wherein the indication of the power amplifier nonlinearity state includes one or more of: a first indication of a first power amplifier state for a first channel, or a second indication of a second power amplifier state for a second channel.

Aspect 20: A method of wireless communication performed by a first wireless communication device comprising: transmitting, to a second wireless communication device, an indication of a power amplifier nonlinearity state used to transmit a communication; and transmitting, to the second wireless communication device, the communication based at least in part on the power amplifier nonlinearity state.

Aspect 21: The method of Aspect 20, further comprising: receiving an indication of an estimated nonlinearity of a transmission port used to transmit the communication, wherein the estimated nonlinearity of the transmission port is based at least in part on the indication of the power amplifier nonlinearity state.

Aspect 22: The method of any of Aspects 20-21, wherein the indication of the power amplifier nonlinearity state comprises one or more of: an identification of the power amplifier nonlinearity state used to transmit the communication, an indication that a same set of power amplifier parameters is used for a series of transmitted communications, or an indication of an amount of modifications to a set of power amplifier parameters, from a previously transmitted communication, to be applied to a transmission of the communication.

Aspect 23: The method of Aspect 22, wherein the series of transmitted communications comprises: a transmission of the communication, and one or more of: a transmission of a previous communication, or a transmission of a subsequent communication.

Aspect 24: The method of any of Aspects 22-23, wherein the indication of the power amplifier nonlinearity state is to be applied to the series of transmitted communications based at least in part on one or more of: an indicated number of transmissions to include in the series of transmitted communications, a configured number of transmissions to include in the series of transmitted communications, an indicated amount of time in which transmissions are to be included in the series of transmitted communications, a configured amount of time in which transmissions are to be included in the series of transmitted communications, or all transmissions for one or more channels until reception of an additional indication of the power amplifier nonlinearity state.

Aspect 25: The method of any of Aspects 20-24, wherein the power amplifier nonlinearity state comprises a power amplifier transmission configuration indicator state.

Aspect 26: The method of any of Aspects 20-25, wherein transmitting the indication of the power amplifier nonlinearity state comprises: transmitting the indication of the power amplifier nonlinearity state via one or more of: a downlink control information message, a sidelink control information message, radio resource control signaling, or one or more medium access control control elements.

Aspect 27: The method of any of Aspects 20-26, wherein the indication of the power amplifier nonlinearity state includes one or more of: a first indication of a first power amplifier state for a first channel, or a second indication of a second power amplifier state for a second channel.

Aspect 28: A method of wireless communication performed by a first wireless communication device, comprising: transmitting, to a second wireless communication device, an indication of a power amplifier nonlinearity state to use for transmitting a communication to the first wireless communication device; and estimating a nonlinearity of the communication based at least in part on the indication of the power amplifier nonlinearity state.

Aspect 29: The method of Aspect 28, further comprising one or more of: performing digital post distortion correction for the communication based at least in part on estimating the nonlinearity of the communication; or transmitting, to the second wireless communication device, an indication of an estimated nonlinearity of the communication.

Aspect 30: The method of any of Aspects 28-29, wherein estimating the nonlinearity of the communication based at least in part on the indication of the power amplifier nonlinearity state comprises: estimating the nonlinearity based at least in part on pilot measurements of one or more additional communications transmitted by the second wireless communication device.

Aspect 31: The method of any of Aspects 28-30, wherein the indication of the power amplifier nonlinearity state comprises one or more of: an identification of the power amplifier nonlinearity state to use for transmitting the communication, an indication to use a same set of power amplifier parameters for a series of transmitted communications, or a threshold amount of allowable modifications to a set of power amplifier parameters for a series of transmitted communications.

Aspect 32: The method of Aspect 31, wherein the series of transmitted communications comprises: a transmission of the communication, and one or more of: a transmission of a previous communication, or a transmission of a subsequent communication.

Aspect 33: The method of any of Aspects 31-32, wherein the indication of the power amplifier nonlinearity state is to be applied to the series of transmitted communications based at least in part on one or more of: an indicated number of transmissions to include in the series of transmitted communications, a configured number of transmissions to include in the series of transmitted communications, an indicated amount of time in which transmissions are to be included in the series of transmitted communications, a configured amount of time in which transmissions are to be included in the series of transmitted communications, or all transmissions for one or more channels until reception of an additional indication of the power amplifier nonlinearity state.

Aspect 34: The method of any of Aspects 28-33, wherein the power amplifier nonlinearity state comprises a power amplifier transmission configuration indicator state.

Aspect 35: The method of any of Aspects 28-34, wherein transmitting the indication of the power amplifier nonlinearity state comprises: transmitting the indication of the power amplifier nonlinearity state via one or more of: a downlink control information message, a sidelink control information message, radio resource control signaling, or one or more medium access control control elements.

Aspect 36: The method of any of Aspects 28-35, wherein the indication of the power amplifier nonlinearity state includes one or more of: a first indication of a first power amplifier state for a first channel, or a second indication of a second power amplifier state for a second channel.

Aspect 37: The method of any of Aspects 28-36, wherein the power amplifier nonlinearity state is based at least in part on one or more of: a transmission port used to transmit the communication, a transmission beam used to transmit the communication, a power amplifier gain state used to transmit the communication, or a power amplifier supply voltage state used to transmit the communication.

Aspect 38: The method of any of Aspects 28-37, further comprising: receiving an indication of a capability of the second wireless communication device to transmit the communication based at least in part on the indication of the power amplifier nonlinearity state.

Aspect 39: An apparatus for wireless communication at a device, comprising a processor; memory coupled with the processor; and instructions stored in the memory and executable by the processor to cause the apparatus to perform the method of one or more of Aspects 1-38.

Aspect 40: A device for wireless communication, comprising a memory and one or more processors coupled to the memory, the one or more processors configured to perform the method of one or more of Aspects 1-38.

Aspect 41: An apparatus for wireless communication, comprising at least one means for performing the method of one or more of Aspects 1-38.

Aspect 42: A non-transitory computer-readable medium storing code for wireless communication, the code comprising instructions executable by a processor to perform the method of one or more of Aspects 1-38.

Aspect 43: A non-transitory computer-readable medium storing a set of instructions for wireless communication, the set of instructions comprising one or more instructions that, when executed by one or more processors of a device, cause the device to perform the method of one or more of Aspects 1-38.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A first wireless communication device for wireless communication, comprising:
a memory; and
one or more processors, coupled to the memory, configured to:
receive an indication of a power amplifier nonlinearity state to use for transmitting a communication to a second wireless communication device; and
transmit the communication based at least in part on the indication of the power amplifier nonlinearity state.

2. The first wireless communication device of claim 1, wherein the indication of the power amplifier nonlinearity state comprises one or more of:
an identification of the power amplifier nonlinearity state to use for transmitting the communication,
an indication to use a same set of power amplifier parameters for a series of transmitted communications, or
a threshold amount of allowable modifications to a set of power amplifier parameters for a series of transmitted communications.

3. The first wireless communication device of claim 2, wherein the indication of the power amplifier nonlinearity state is to be applied to the series of transmitted communications based at least in part on one or more of:
an indicated number of transmissions to include in the series of transmitted communications,
a configured number of transmissions to include in the series of transmitted communications,
an indicated amount of time in which transmissions are to be included in the series of transmitted communications,
a configured amount of time in which transmissions are to be included in the series of transmitted communications, or
all transmissions for one or more channels until reception of an additional indication of the power amplifier nonlinearity state.

4. The first wireless communication device of claim 1, wherein the indication of the power amplifier nonlinearity state indicates to use a same set of power amplifier parameters for a series of transmitted communications, and wherein the one or more processors are further configured to determine a transmission power for respective transmissions of the series of transmitted communications based at least in part on a same pathloss measurement.

5. The first wireless communication device of claim 1, wherein the power amplifier nonlinearity state comprises a power amplifier transmission configuration indicator state.

6. The first wireless communication device of claim 1, wherein the indication of the power amplifier nonlinearity state includes one or more of:
a first indication of a first power amplifier state for a first channel, or
a second indication of a second power amplifier state for a second channel.

7. The first wireless communication device of claim 1, wherein the power amplifier nonlinearity state is based at least in part on one or more of:
a transmission port used to transmit the communication,
a transmission beam used to transmit the communication,
a power amplifier gain state used to transmit the communication, or
a power amplifier supply voltage state used to transmit the communication.

8. The first wireless communication device of claim 1, wherein the one or more processors are further configured to:
transmit an indication of a capability of the first wireless communication device to transmit the communication based at least in part on the indication of the power amplifier nonlinearity state.

9. A first wireless communication device for wireless communication, comprising:
a memory; and
one or more processors, coupled to the memory, configured to:
receive, from a second wireless communication device, an indication of a power amplifier nonlinearity state used by the second wireless communication device to transmit a communication; and
estimate a nonlinearity of the communication based at least in part on the indication of the power amplifier nonlinearity state.

10. The first wireless communication device of claim 9, wherein the one or more processors are further configured to one or more of:
perform digital post distortion correction for the communication based at least in part on estimating the nonlinearity of the communication; or
transmit, to the second wireless communication device, an indication of an estimated nonlinearity of the communication.

11. The first wireless communication device of claim 9, wherein the one or more processors, to estimate the nonlinearity of the communication based at least in part on the indication of the power amplifier nonlinearity state, are configured to:
estimate the nonlinearity based at least in part on pilot measurements of one or more additional communications transmitted by the second wireless communication device.

12. The first wireless communication device of claim 9, wherein the indication of the power amplifier nonlinearity state comprises one or more of:
an identification of the power amplifier nonlinearity state used to transmit the communication,
an indication that a same set of power amplifier parameters is used for a series of transmitted communications, or
an indication of an amount of modifications to a set of power amplifier parameters, from a previously transmitted communication, to be applied to a transmission of the communication.

13. The first wireless communication device of claim 12, wherein the indication of the power amplifier nonlinearity state is to be applied to the series of transmitted communications based at least in part on one or more of:
an indicated number of transmissions to include in the series of transmitted communications,
a configured number of transmissions to include in the series of transmitted communications,
an indicated amount of time in which transmissions are to be included in the series of transmitted communications,
a configured amount of time in which transmissions are to be included in the series of transmitted communications, or
all transmissions for one or more channels until reception of an additional indication of the power amplifier nonlinearity state.

14. The first wireless communication device of claim 9, wherein the power amplifier nonlinearity state comprises a power amplifier transmission configuration indicator state.

15. The first wireless communication device of claim 9, wherein the indication of the power amplifier nonlinearity state includes one or more of:
a first indication of a first power amplifier state for a first channel, or
a second indication of a second power amplifier state for a second channel.

16. A first wireless communication device comprising for wireless communication, comprising:
a memory; and
one or more processors, coupled to the memory, configured to:
transmit, to a second wireless communication device, an indication of a power amplifier nonlinearity state used to transmit a communication; and
transmit, to the second wireless communication device, the communication based at least in part on the power amplifier nonlinearity state.

17. The first wireless communication device comprising of claim 16, wherein the one or more processors are further configured to:
receive an indication of an estimated nonlinearity of a transmission port used to transmit the communication,
wherein the estimated nonlinearity of the transmission port is based at least in part on the indication of the power amplifier nonlinearity state.

18. The first wireless communication device comprising of claim 16, wherein the indication of the power amplifier nonlinearity state comprises one or more of:
an identification of the power amplifier nonlinearity state used to transmit the communication,
an indication that a same set of power amplifier parameters is used for a series of transmitted communications, or
an indication of an amount of modifications to a set of power amplifier parameters, from a previously transmitted communication, to be applied to a transmission of the communication.

19. The first wireless communication device comprising of claim 18, wherein the indication of the power amplifier nonlinearity state is to be applied to the series of transmitted communications based at least in part on one or more of:
an indicated number of transmissions to include in the series of transmitted communications,
a configured number of transmissions to include in the series of transmitted communications,
an indicated amount of time in which transmissions are to be included in the series of transmitted communications,
a configured amount of time in which transmissions are to be included in the series of transmitted communications, or
all transmissions for one or more channels until reception of an additional indication of the power amplifier nonlinearity state.

20. The first wireless communication device comprising of claim 16, wherein the power amplifier nonlinearity state comprises a power amplifier transmission configuration indicator state.

21. The first wireless communication device comprising of claim 16, wherein the indication of the power amplifier nonlinearity state includes one or more of:
a first indication of a first power amplifier state for a first channel, or
a second indication of a second power amplifier state for a second channel.

22. A first wireless communication device for wireless communication, comprising:
a memory; and
one or more processors, coupled to the memory, configured to:
transmit, to a second wireless communication device, an indication of a power amplifier nonlinearity state to use for transmitting a communication to the first wireless communication device; and
estimate a nonlinearity of the communication based at least in part on the indication of the power amplifier nonlinearity state.

23. The first wireless communication device of claim 22, wherein the one or more processors are further configured to one or more of:
perform digital post distortion correction for the communication based at least in part on estimating the nonlinearity of the communication; or
transmit, to the second wireless communication device, an indication of an estimated nonlinearity of the communication.

24. The first wireless communication device of claim 22, wherein the one or more processors, to estimate the nonlinearity of the communication based at least in part on the indication of the power amplifier nonlinearity state, are configured to:
estimate the nonlinearity based at least in part on pilot measurements of one or more additional communications transmitted by the second wireless communication device.

25. The first wireless communication device of claim 22, wherein the indication of the power amplifier nonlinearity state comprises one or more of:
an identification of the power amplifier nonlinearity state to use for transmitting the communication,
an indication to use a same set of power amplifier parameters for a series of transmitted communications, or
a threshold amount of allowable modifications to a set of power amplifier parameters for a series of transmitted communications.

26. The first wireless communication device of claim 25, wherein the indication of the power amplifier nonlinearity state is to be applied to the series of transmitted communications based at least in part on one or more of:
an indicated number of transmissions to include in the series of transmitted communications,
a configured number of transmissions to include in the series of transmitted communications,
an indicated amount of time in which transmissions are to be included in the series of transmitted communications,
a configured amount of time in which transmissions are to be included in the series of transmitted communications, or
all transmissions for one or more channels until reception of an additional indication of the power amplifier nonlinearity state.

27. The first wireless communication device of claim 22, wherein the power amplifier nonlinearity state comprises a power amplifier transmission configuration indicator state.

28. The first wireless communication device of claim 22, wherein the one or more processors, to transmit the indication of the power amplifier nonlinearity state, are configured to:
transmit the indication of the power amplifier nonlinearity state via one or more of:
a downlink control information message,
a sidelink control information message,
radio resource control signaling, or
one or more medium access control control elements.

29. The first wireless communication device of claim 22, wherein the power amplifier nonlinearity state is based at least in part on one or more of:
a transmission port used to transmit the communication,
a transmission beam used to transmit the communication,
a power amplifier gain state used to transmit the communication, or
a power amplifier supply voltage state used to transmit the communication.

30. The first wireless communication device of claim 22, wherein the one or more processors are further configured to:
receive an indication of a capability of the second wireless communication device to transmit the communication based at least in part on the indication of the power amplifier nonlinearity state.
receiving an indication of a capability of the second wireless communication device to transmit the communication based at least in part on the indication of the power amplifier nonlinearity state.
